(19) United States
(12) Patent Application Publication
(10) Pub. No.: US 2012/0323695 A1
(43) Pub. Date: Dec. 20, 2012

(54) Lead Generation Platform

(75) Inventor: Aaron B. Stibel, Malibu, CA (US)

(73) Assignee: Credibility Corp.

(21) Appl. No.: 13/495,860

(22) Filed: Jun. 13, 2012

Related U.S. Application Data
(60) Provisional application No. 61/497,223, filed on Jun. 15, 2011.

(51) Int. Cl. G06Q 30/02

(52) U.S. Cl. 705/14.66

(57) ABSTRACT

Some embodiments provide a lead generation platform to promote lead generation on the basis reciprocity, whereby a business participating in the platform obtains access to the leads of other participating businesses that it has established network partnerships with and in return, makes its leads accessible to the other participating businesses. Leads can then be filtered to target a business' primary demographic and the filtered leads used to conduct a marketing campaign without intervening marketing service providers. As a result, a business identifies its primary demographic without engaging in costly market research. Also, by being able to control network partnerships, the business can gain access to a set of non-competing leads and valued existing customers of other businesses which is in contrast to the leads provided by other third party services, whereby one's competitors have access to the same sets of leads.

### CLAIM OF BENEFIT TO RELATED APPLICATIONS

This application claims the benefit of U.S. provisional application 61/497,223, entitled “Lead Generation Platform”, filed Jun. 15, 2011. The contents of the provisional application 61/497,223 are hereby incorporated by reference.

### TECHNICAL FIELD

The present invention pertains to a system, methods, and software products for business lead generation.

### BACKGROUND

Marketing is an essential element to the success of any business. It assists in driving new clients to a business and assists in retaining existing clients. Marketing is conducted in many different forms across many different mediums. For example, coupons, promotions, press releases, branding, and other advertising represent various forms of marketing. Online, print, radio, and television represent various different mediums across which marketing can be performed.

There are several keys to effective marketing. Firstly, effective marketing involves targeting the primary client demographic. This ensures that the persons most interested in the goods and services offered by a business are those receiving the marketing materials of the business. However, identifying the primary client demographic is often a difficult task for a small business given its resource constraints. For instance, even though a small business may know the characteristics of its primary demographic (e.g., age, income, profession, etc.), it sometimes does not have the resources to find the actual persons meeting such characteristics. Companies have been established to identify and sell leads to such clientele. However, small businesses typically do not have the financial resources to purchase leads from such lead generation companies.

Effective marketing also involves creating a successful marketing campaign that monetizes on any obtained leads to the primary client demographic irrespective on how those leads are obtained. In other words, the value obtained from the volume of disseminated marketing materials or “value-to-volume ratio” should exceed some specified threshold. To this end, a business can conduct market research to identify how best to monetize on its leads. As some examples, market research can be conducted to (1) identify the “hot” goods and services that clients are interested in, (2) identify competitive rates for goods and services, and (3) identify current and upcoming practices of one's competitors. With this information in hand, a business can avoid spamming potential leads, and instead provide them with interesting and engaging marketing materials. Market research can be conducted on behalf of a business by third party market research companies. For a small business, market research is often an expense that is beyond the fiscal means of the small business. Market research can also be conducted by the business itself. Oftentimes however, a small business has too few resources to allocate for such matters.

Yet another key to effective marketing involves establishing and maintaining client loyalty. While the actual goods and services provided by a business are the primary means with which a business establishes client loyalty, such loyalty cannot take root without first attracting potentially loyal clients to the business. Therefore, it is to the benefit of the business to (1) target clients that have been loyal to other businesses as these clients have a history of transacting with a particular business once introduced to and satisfied by the goods and services offered by the particular business and (2) target non-competing leads. A non-competing lead is one that is not the subject and target of promotions from competitors. Competing leads can create a “race to the bottom” scenario where each competing business outdoes the promotions of the other competing businesses in order to gain the business of that lead. Also, a competing lead has no incentive to return to a particular business when it is continually being offered discounted promotions from various competing business. Accordingly, a competing lead will transact with whichever business offers the latest promotion, whereas a loyal client will be willing to pay a price premium to stay with a trusted business and a non-competing lead will be more likely to stay on as a loyal client. Here again, the small business is at a disadvantage as it does not have the necessary resources to identify such clientele itself or to outsource the effort to other third parties.

Online marketing has helped alleviate some of the marketing obstacles that small businesses face. Through online advertisers and search engines, a small business can cost-effectively target its primary demographic without having to purchase leads and without having to engage in costly market research. Online advertisers and search engines usually have extensive databases that a business can use to identify its primary demographic and thereby direct a marketing campaign to such persons. However, a shortcoming of such marketing is the low conversion rate that results. Specifically, many users perceive website advertisements as spam and avoid them as a result, regardless of the advertisements relevancy or amount of sparked user interest. Also, there is no guarantee that even though a user clicks on an advertisement that a purchase or transaction will be completed. Yet, the business is still charged for the presentation of the advertisement and/or the user clicking on the advertisement. Consequently, online advertising and search engine marketing usually results in poor value-to-volume ratios.

Still another form of online marketing involves using services provided by Groupon (www.groupon.com), LivingSocial (www.livingsocial.com), and other similar marketing service providers. These companies allow businesses to market promotions to their primary demographic with a higher value-to-volume ratio. Specifically, promotions are sent to a set of leads and if a lead is interested in the promotion, that lead is able to purchase the promotion which can then be redeemed for a good or service at a future time. When a promotion is purchased, the purchase fee is shared amongst the business and the marketing service provider (e.g., www.groupon.com or www.livingsocial.com). In such marketing models, the business is not subjected to marketing costs upfront, but is subjected to a cost whenever a sale is consummated.

Marketing through services such as Groupon and the like still does not address the issue of client loyalty and client retention. In fact, these forms of marketing actually promote the opposite behavior by appealing to clientele seeking the best current promotion and by appealing to clientele seeking onetime transactions. Another shortcoming is that a business and its competitors can use the same service thereby targeting the same primary demographic with competing promotions.

Accordingly, there is a need to provide more effective marketing through a lead generation platform that allows businesses to target their primary demographic, obtain a high value-to-volume ratio for their marketing efforts, and retain clients that are identified through the marketing campaign. There is further a need to tailor such a platform for small businesses. Specifically, there is a need to provide a platform that allows small businesses to have access to the same or similar marketing resources as larger businesses without the costs associated with maintaining large client databases and conducting extensive market research.

### SUMMARY OF THE INVENTION

It is an object of the present invention to define a system, methods, and computer software products to provide a lead generation platform for businesses to more effectively and cost efficiently perform marketing. More specifically, it is object of the lead generation platform to promote lead generation on the basis reciprocity, whereby a business participating in the lead generation platform obtains access to the leads of other participating businesses when the participating business makes its leads accessible to the other participating businesses. It is further an object of the lead generation platform to allow a participating business to filter the leads it obtains in order to target the participating business' primary demographic. It is further an object to allow a participating business to perform targeted marketing that provides a high value-to-volume ratio by disseminating promotions for discounted future goods and services. It is further an object of the lead generation platform to improve the retention of clients that are obtained through the leads by targeting clients of other businesses that have long standing relationships with those other businesses and by marketing to a set of non-competing leads.

To achieve these and other objects, some embodiments provide a lead generation platform. The lead generation platform allows a business to handshake with other businesses. A successful handshake establishes each business of the handshake as a network partner of the other. Network partnerships are established to facilitate mutually beneficial relationships predicated on the reciprocity of business resources. One such resource is the reciprocal sharing of leads between network partners. The more businesses one handshakes with, the greater the pool of potential leads that the business will have access to and that the business can market to. Once network partnerships are established, the business will have access to the leads of its network partners. By selectively choosing one's network partners, a particular business can ensure that the leads it obtains are non-competing leads. Also, by selectively choosing one's network partners, the particular business can ensure that its existing clients that are shared as leads to other businesses only receive marketing promotions from the other businesses that are of interest and value to its existing clients.

The business can filter the leads of its network partners to identify leads that fall within the primary demographic of clients for the business. A business participating in the lead generation platform can then manage and conduct its own marketing campaign to the filtered leads. In this manner, the business can conduct its own Groupon style marketing campaign without having to share fees with a third party promoter such as Groupon or LivingSocial. Costs are further reduced as the lead generation platform allows the business to identify its primary demographic without engaging in costly market research and without the business relying on third parties such as Groupon or LivingSocial to conduct costly marketing campaigns in order to drum up interest for the business. Also, by being able to control network partnerships, the business can gain access to a set of non-competing leads and valued existing customers of other businesses which is in contrast to the leads provided by services like Groupon or LivingSocial, whereby one's competitors have access to the same sets of leads. Other advantages gained from the lead generation platform include (1) leveraging reciprocity to create a shared pool of resources for networked businesses that is much larger than what would otherwise be available to a single business and (2) facilitating a self-growing platform whereby each participating business increases the size of the resource pool of leads and in so doing, provides more incentives for new businesses to participate.

### BRIEF DESCRIPTION OF THE DRAWINGS

In order to achieve a better understanding of the nature of the present invention a preferred embodiment of the lead generation platform system and methods will now be described, by way of example only, with reference to the accompanying drawings in which:

FIG. 1 presents a process performed by the lead generation platform for enabling a business access to a pooled set of leads in accordance with some embodiments.

FIG. 2 conceptually illustrates performing handshaking in accordance with some embodiments of the lead generation platform.

FIG. 3 conceptually illustrates the partnership links that are formed as a result of businesses accepting a handshaking request from a particular business.

FIG. 4 conceptually illustrates identifying two businesses of interest from already established network partners, and handshaking with those businesses in accordance with some embodiments.

FIG. 5 presents a process performed by the lead generation platform to automatically disseminate a marketing campaign on behalf of a participating business in accordance with some embodiments

FIGS. 6-7 conceptually illustrate the reciprocal manner in which the lead generation platform operates.

FIG. 8 conceptually illustrates filtering the leads that receive a marketing campaign based on supplemental demographic information that are provided as part of the marketing campaign in accordance with some embodiments.

FIG. 9 illustrates users specifying lead access controls in accordance with some embodiments.

FIG. 10 illustrates various components and modules of a lead generation platform that is in accordance with some embodiments

FIG. 11 illustrates a computer system with which some embodiments are implemented.

### DETAILED DESCRIPTION OF THE INVENTION

In the following detailed description, numerous details, examples, and embodiments of a lead generation platform system and methods are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

### I. Lead Generation Platform

A. Overview

Some embodiments include a lead generation platform that provides an interactive environment for businesses to connect with one another and share resources. Such a platform empowers the small business to compete at the level of much larger businesses by pooling the resources of the small businesses and allowing each small business participating in the pool to have access to the resources therein. One resource of particular importance to the small business is a set of leads to its target demographic. The lead generation platform is predicated on reciprocity, whereby a participating business shares its leads with its network partners in order to gain access to and market to the leads of its network partners. A network partner includes a business with an established relationship or partnership with another business, whereby the relationship or partnership is established using a handshaking process in some embodiments.

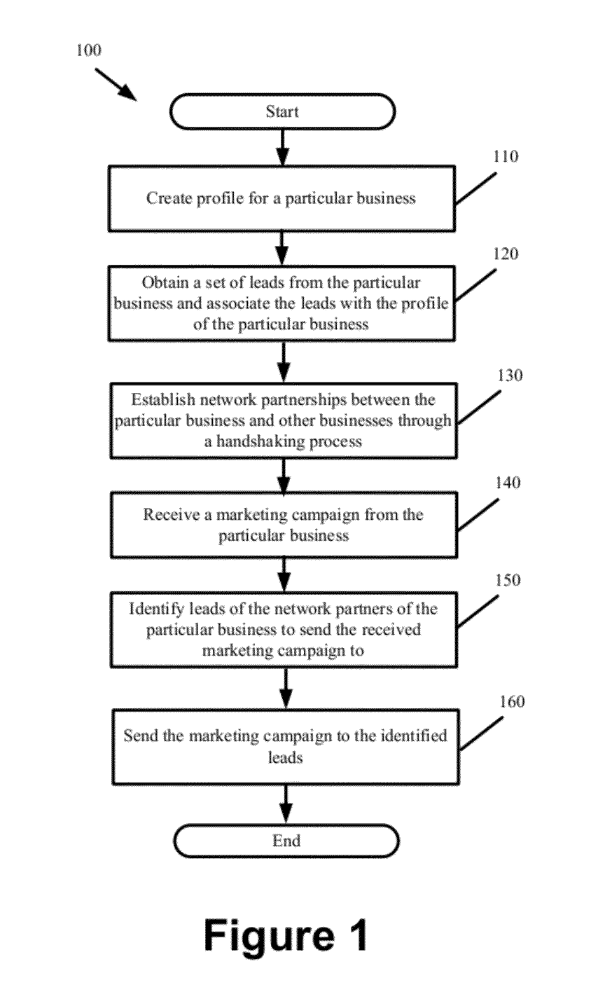

FIG. 1 presents a process 100 performed by the lead generation platform for enabling a business access to a pooled set of leads to which the business can conduct a targeted marketing campaign in accordance with some embodiments. The process 100 begins by registering a business to participate in the lead generation platform. Registration involves the creation (at 110) of a profile for the particular business within the lead generation platform. Registration involves obtaining (at 120) a set of leads from the particular business to facilitate the subsequent reciprocal exchange of leads with other businesses. The obtained set of leads includes contact information for an existing set of clients of the registering business. In some embodiments, the registering business is restricted to uploading leads that have agreed to receive marketing materials from the registering business as well as other businesses. The contact information may include one or more of an email address, telephone number, and mailing address as some examples. In some embodiments, the obtained set of leads further includes demographic information for each lead, such as age, geographic region, preferred goods and services, prior transaction history, etc. The obtained set of leads is associated with the profile of the particular business.

The process establishes (at 130) network partnerships between the particular business and other businesses through a handshaking process that occurs amongst participating businesses of the lead generation platform. In some embodiments, the handshaking process involves the sending of an invite from a first business to at least a second business. To do so, the first business identifies an already created profile for the second business on the lead generation platform. The first business then invokes a handshaking procedure by clicking or otherwise selecting a handshaking icon on the profile of the second business when the second business is not already a network partner of the first business. Each business profile is associated with a valid and active email address and clicking on the handshaking link causes the lead generation platform to submit a handshaking invite to the email address of the second business indicating that the first business desires to establish a network partnership with the second business. The invite may further include additional information about the first business. The second business can then choose whether to accept or decline the invite. The second business becomes a network partner of the first business when the second business accepts the handshake. If the handshake is accepted, the second business is added as a network partner of the first business and vice versa. The above described process is one manner with which to conduct the handshaking process. Other handshaking processes are similarly applicable and are within the scope of the lead generation platform of some embodiments. When a network partnership is established, each partner in the partnership is provided access to the leads registered to the profile of the other partner. While leads are one shareable resource between network partners, it should be apparent to one of ordinary skill in the art that other resources are similarly shareable and can be used as a substitute for the embodiments described using leads.

The process receives (at 140) a marketing campaign from the particular business. In some embodiments, the marketing campaign includes at least one promotion of a good or service such as the Groupon style of discounted goods and services that can be purchased and redeemed for subsequent use. However, the marketing campaign can include other marketing materials such as informational content, news releases, coupons, etc.

The process identifies (at 150) leads of the network partners of the particular business to send the received marketing campaign to. This step can be driven automatedly or manually. The process can automatically identify all leads of all network partners to send the received marketing campaign to or the process can automatically identify leads that have been newly uploaded by the network partners and that have yet to receive marketing materials from the particular business and the process sends the marketing campaign to those leads. Alternatively or additionally, the process can identify a subset of leads from a subset of network partners based on demographic information that is manually specified by the particular business or based on a selection of a subset of network partners. The process concludes by sending (at 160) the marketing campaign to the identified leads.

It should be apparent that process 100 can be performed for any participating business of the lead generation platform and that the process 100 can be repeated without steps 110-130 for businesses that have already registered with the lead generation platform.

In some embodiments, the leads of the participating businesses that have been provided to the lead generation platform are never exposed to participating businesses or even to one's network partners. Rather, the leads are confidentially maintained in a database of the lead generation platform. This prevents a business from misusing or spamming leads that are clients of other businesses.

In some embodiments, marketing materials are disseminated using one or more of email, short message service (SMS), text message, social network messaging (e.g., www.twitter.com “tweets” and www.facebook.com “wall posts”), voice messages, and physical mailings.

In some embodiments, the functionality and services of the lead generation platform are provided free of charge and the lead generation platform generates revenue by utilizing the network partnership information for other purposes including generation and sale of business credit scores, credit report, credibility scores, and credibility reports. In some embodiments, the functionality and services of the lead generation platform are provided based on a business registration fee or subscription fee. For example, each participating business pays a monthly fee to have its profile listed and to have access to the leads of its network partners. In some embodiments, the lead generation platform collects a nominal fee to each lead that receives the marketing materials or a nominal fee is assessed whenever a marketing campaign is performed. In still some other embodiments, a service fee model is used that is similar to the one used by Groupon, whereby the lead generation platform receives some portion of the value of the promotions that are sold based on the provided leads. However, the fees of the lead generation platform are substantially lower than those of other website marketing services such as Groupon, because the lead generation platform passively obtains its leads from its participating businesses. This is in direct contrast to existing marketing service providers, such as Groupon and LivingSocial, that actively obtain their leads through expensive marketing campaigns, wherein the marketing campaigns are conducted to encourage potential clients to sign up and receive promotions from participating businesses of the marketing service provider.

B. Advantages

The lead generation platform is a self-feeding and self-growing platform wherein the resource pool of the lead generation platform grows with each participating business (as participating business are required to share some resource with their network partners) and the incentive for new businesses to participate grows as the resource pool grows. This is because the cost-to-value ratio for participating in the lead generation platform becomes more disproportionate as more businesses participate. For example, when each participating business is required to provide at least five leads to register and the lead generation platform consists of two registered businesses, there will be a one-to-one return for each lead that is provided by a registered business. However, when there are three participating businesses, the lead generation platform has a total of fifteen leads such that a business will receive a two-for-one return for each lead that is provided by that business. The foregoing example is provided for conceptual purposes. The lead generation platform is envisioned to have several thousand business participants.

The lead generation platform also provides leads on the basis of reciprocity, whereby a particular business can obtain access to the leads of other businesses by making its leads available to the other businesses in return. Accordingly, unlike marketing services such as Groupon and LivingSocial, the lead generation platform advocated herein need not engage in costly marketing campaigns in order to build up its resource pool of leads. Therefore, the lead generation platform has no extraneous costs to pass on to its business participants. As a result, businesses utilizing the lead generation platform advocated herein can conduct effective marketing campaigns at much lower cost than when utilizing other marketing services such as Groupon and LivingSocial.

Furthermore, by selectively establishing one's network partners, a particular business can enter into relationships with other businesses that have aligned non-competing interests. This provides the business with three primary advantages. Firstly, the business gains access to a resource pool of leads that target the primary demographic of the particular business without the business having to conduct costly market research in order to identify such leads. Specifically, businesses having aligned non-competing interests will have clientele within the same primary demographic. Therefore, it is simply a matter of identifying those aligned non-competing businesses in order to identify one's primary demographic of clientele. Secondly, selectively establishing one's network partners improves the value to one's clients (that are shared as leads to other businesses). The clients that are shared as leads only receive marketing materials from network partners that are screened by the business sharing the clients as leads as a result of the handshaking process by which network partnerships are established. In other words, a first business may decline a network partnership with a second business that is not reputable or that offers low quality goods and services while accepting a network partnership with a third business that is reputable or that offer high quality goods and services. In so doing, the first business screens the marketing materials that are sent to its clients, thereby preventing marketing materials that are not of interest or are irrelevant to its clients from ever reaching its clients, while allowing marketing materials that are of interest to reach its clients. Thirdly, the selective establishment of one's network partners also provides the added benefit of a business being able to target a set of non-competing leads that is not marketed to by the business' direct competitors. Specifically, by analyzing the network partners of a particular business before handshaking with that particular business, one can ascertain whether competitors have obtained access to the leads of that particular business. Marketing to such non-competing leads results in higher client retention. Client retention is also improved because the leads provided by the participating businesses will often include clients of the participating businesses that have established long standing relationships or loyal relationships with those businesses and as a result, these clients are more likely to return to a business once introduced to that business.

The lead generation platform thus provides an equally effective marketing platform as marketing services such as Groupon and LivingSocial with much lower cost because of the no-cost reciprocal approach by which the lead generation platform obtains leads and allows participants to identify their primary demographic of clientele.

### II. Operation

A. Business Profiles

To participate in the lead generation platform, a business first creates a profile that identifies the business within the lead generation platform. The profile is an identity or account for the business at an online portal that is operated by the lead generation platform. The portal is accessible by directing a web browser or other application running on a network enabled device to a Uniform Resource Locator (URL) or domain of the lead generation platform.

A new business participant can initiate the profile creation procedure by invoking a registration function presented on the portal. The profile creation procedure is a registration procedure that obtains one or more of the business name, location, offered goods and services, credit score, credibility score, and other identification information for the business. The profile information may be populated by the business through an online interface of the lead generation platform. Alternatively, the profile information may be populated automatically by the lead generation platform by accessing such information from third party business databases, such as the business database maintained by Dun & Bradstreet Credibility or by www.linkedin.com.

A username and password or other identifier(s) are associated with each business profile and are used to identify a business participant within the lead generation platform and to provide the business participant access to the services of the lead generation platform. In some embodiments, the created profiles and associated information are stored within a database of the lead generation platform.

Once a profile is created or as part of the profile creation procedure, the lead generation platform requests the business that is associated with the profile upload a set of leads to include as part of the business profile. The set of leads are entered as part of the business profile or, generally, to the lead generation platform. Here again, a web interface is used to facilitate the entry of the set of leads.

In some embodiments, the set of leads includes leads that the business is willing to share with other businesses. Leads typically consist of existing clients of the business, though they may also include persons on a mailing list or subscription service of the business, persons that have requested information from the business, persons or other business that provide goods or other services to the business, or persons that the business has information on otherwise. For In some embodiments, certain disclosures may have to be made to persons before they can be entered as leads. This may include providing a disclaimer to business clients that client information provided to the business may be used for marketing purposes by the business and its network partners. Alternatively, clients that wish to sign up for special promotions or other marketing materials of a business may affirm that they are willing to have their information shared with network partners of the business. These disclosures may be optional or required depending on compliance requirements of the jurisdiction in which the lead generation platform operates.

In some embodiments, entering a lead includes providing contact information in order for other business participants to contact the lead. The provided contact information may include one or more of an email address for receiving marketing materials via, a telephone number for receiving marketing materials via SMS messaging, text messaging, or voice messages, a Universal Resource Locator (URL) or social network profile for social network messaging such as Twitter tweets and Facebook wall posts, or a mailing address for receiving print marketing materials. It should be apparent that the lead generation platform can support other forms of contact information in addition to those enumerated above in order to disseminate marketing materials through other transfer mediums.

Preferably, additional information is provided for each entered lead in order to supplement the contact information and allow for more targeted usage of that lead by other business participants of the lead generation platform. Such supplemental information may include providing a name or other identifying information for the lead and demographic information that can be used to filter the lead. The demographic information may specify the age, geographic region, income range, sex, profession, etc. of the lead. Such demographic information is used to supplement the targeted marketing performed by the lead generation platform. For example, a movie rental business may partner with a movie theater in order to access the leads entered by the movie theater with the knowledge that the leads provided by the movie theater include clients that enjoy watching movies. Accordingly, the leads provided by the movie theater would fall within the primary demographic of clientele for the movie rental business. Once a network partnership is established between the movie theater and the movie rental business in the lead generation platform, the movie rental business will have access to the movie theater entered leads and can use the supplemental demographic information of the leads to perform a targeted marketing campaign for a movie geared to young males. Specifically, using the supplemental demographic information, the movie rental business can identify leads entered by the movie theater that fall within the age range of 25-35 and that are male in order to increase the effectiveness of the marketing campaign.

In some embodiments, the lead generation platform specifies a minimum number of leads that a business must enter before the business is permitted to access the leads of its network partners. In some embodiments, the lead generation platform makes accessible a certain number of leads from the network partners of a business in proportion to the number of leads that the business has entered. This prevents lead generation participants from abusing the system and from taking unfair advantage of the system. For example, for every one entered lead, a business can access and market to one lead from each of its network partners. In this manner, network partners equally or proportionally contribute to the shared pool of resources. The lead generation platform tracks the number of leads entered by each participating business.

In some embodiments, the entered leads are verified prior to being entered into the lead generation platform. This may include receiving additional information for confirming that a lead is actually a client of the providing business or comparing the contact information that is provided for a lead with an entity database. Verification ensures that a participating business is not faking the leads that are provided to the lead generation platform, thereby ensuring the integrity and quality of the leads that are made available to others participating in the lead generation platform.

B. Network Partners

Once a business has created its profile, the business can begin to establish partnerships with other participating businesses that have profiles in the lead generation platform. A business may partner with another business to learn about the other business, to stay in contact with the other business, to receive informational updates from the other business, to increase its credibility or perceived trustworthiness by being associated with the other business, and to access resources of the other business. For example, a goods providing business may compare various parts supplying businesses based on the created profiles and then partner with a parts supplying business that best suits the needs of the goods providing business. Some of these functions with the exception of accessing resources of the other businesses exist in social media platforms such as LinkedIn, Facebook, and the like.

To establish a partnership, a business identifies the profile of a business that it wishes to partner with. In some embodiments, the profiles can be searched using one of more different identification information. For example, a particular business can search for other businesses that are within the same geographic region as the particular business and/or that provide similar goods and services. Other searchable information includes the name, address, telephone number, domain name, email address, etc. of the business. The searchable information is entered to a query interface of the lead generation platform, whereby the profiles matching closest to the searchable information are returned. After a profile for a desired business is identified in the query results, a handshaking request can be submitted to the profile of that business. The handshaking request is an invite for one business to become a network partner of the requesting business. In some embodiments, the handshaking request is sent via email to the profile of the receiving business on the lead generation platform or to some other email account that the business has specified in its profile for receiving notifications. The lead generation platform supports and can use other forms of notification to alert the receiving business about incoming handshake requests. Some examples of other forms of notification include instant message and text message to a cellular telephone number.

Each handshaking request may include links or functions with which to accept or reject the request, wherein accepting the request establishes the partnership between the two businesses, and wherein rejecting the request prevents the business submitting the handshaking request from gaining access to the leads of the business receiving the handshaking request. Depending on the notification used, the handshaking request may alternatively include a link to one's profile at the lead generation platform or a message of the incoming request directing the business to its own profile at the lead generation platform where it can then respond to the request by accepting or rejecting the request. To aid in the decision making process, the handshaking request includes or provides links to identification information about the business submitting the request. This assists the business receiving the request to identify the business submitting the request and gauge whether a partnership is in the best interest of the business. It is to the benefit of a particular business to partner with other trusted or credible businesses and other businesses that offer similar goods and services. Stated differently, it is to the benefit of the particular business to avoid randomly establishing partnerships with any business and to carefully screen the businesses that it accepts into its own network. Firstly, the trustworthiness and credibility of the particular business is reflected in part through its network partners. Secondly, in order to conduct an effective targeted marketing campaign, the particular business will need access to leads that are within its primary demographic and such leads are most readily accessible from non-competing businesses that offer goods and services that cater to the same demographic or that satisfy a different need of that same demographic. Therefore, there is little to no benefit for a high-end retailer to partner with a fast-food restaurant as the leads of the fast food restaurant will be of no value to the retailer and the partnership with the fast-food when viewed by others may lower the credibility that others attribute to the retailer. Similarly, the leads offered by the fast-food restaurant will likely not want to receive promotions from the high-end retailer. In fact, doing so can detrimentally impact the credibility of the fast-food restaurant when the information and privacy of the leads offered by the fast-food restaurant are freely made accessible to any business for marketing purposes.

In preferred embodiments, the lead generation platform does not place restrictions on which businesses can partner with which businesses. Instead, the businesses self-regulate their partnerships by controlling who they submit handshake requests to and which received handshake requests they accept or decline.

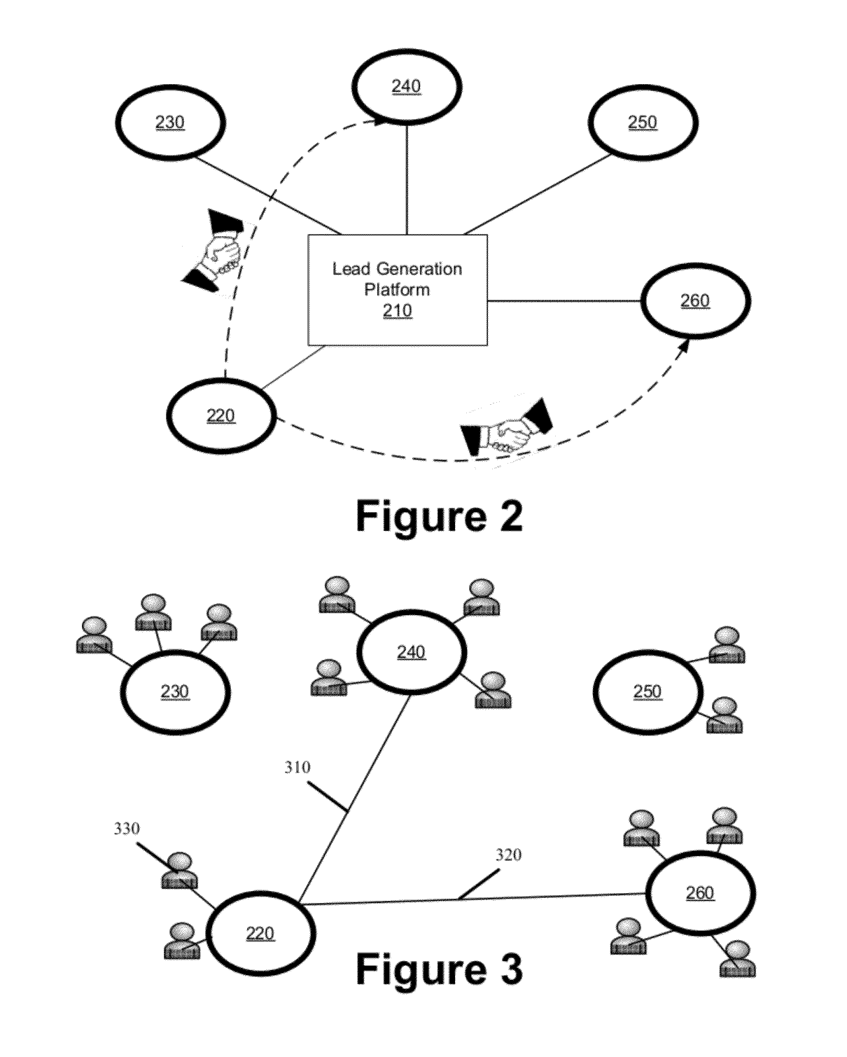

FIG. 2 conceptually illustrates performing the handshaking in accordance with some embodiments of the lead generation platform. In this figure, the lead generation platform 210 contains profiles for five different businesses as represented by the reference markers 220, 230, 240, 250, and 260. Business 220 identifies the profiles for businesses 240 and 260 on the lead generation platform as businesses it is interested in partnering with. Next, business 220 sends a handshaking request through the lead generation platform to each of the businesses 240 and 260. Businesses 240 and 260 receiving the handshaking request are then free to accept or decline the request.

As generally noted above, a first business may want to partner with a second business when the second business is not a direct competitor, is a supplier, is a buyer, is an affiliate, or other business with which a mutually beneficial relationship can be established. A first business may not want to partner with a second business when the second business does not have any resources that would be of value to the first business or when partnering with the second business can hurt the credibility of the first business.

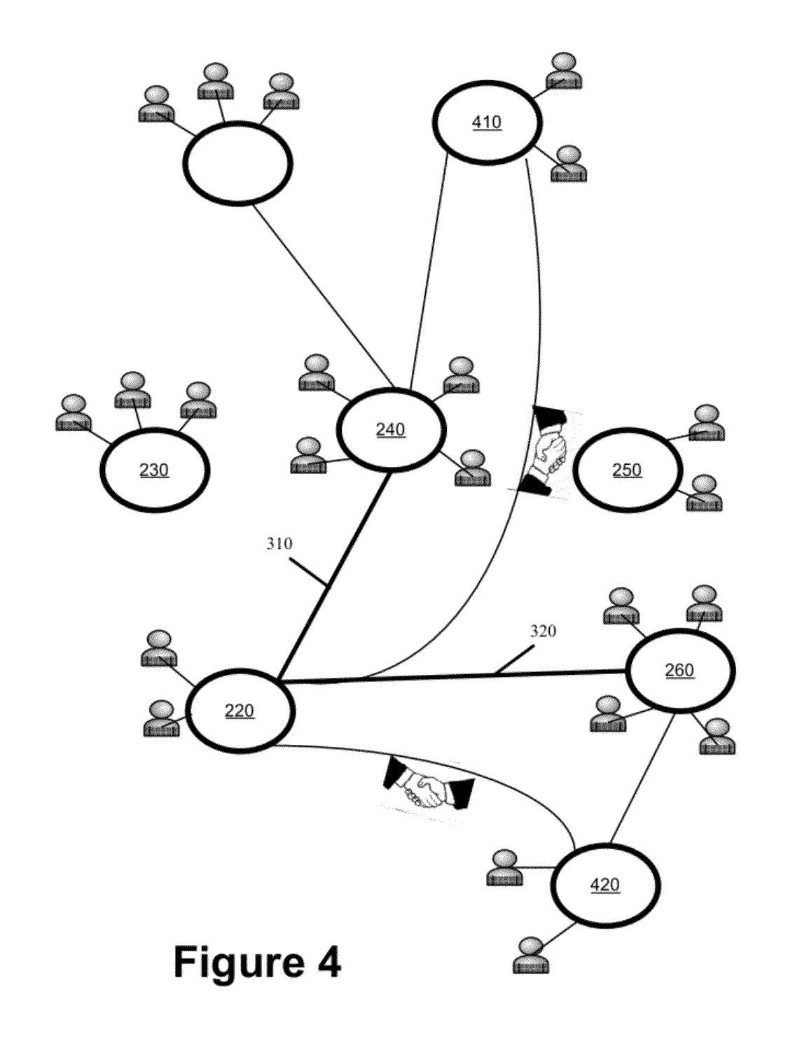

FIG. 3 conceptually illustrates the partnership links 310 and 320 that are formed as a result of businesses 240 and 260 accepting the handshaking request from business 220. Specifically, the graphical link 310 between business 220 and 240 illustrates that business 220 is a network partner of business 240 and that business 240 is a network partner of business 220. The graphical link 320 between business 220 and 260 illustrates that business 220 is a network partner of business 260 and that business 260 is a network partner of business 220. Such partnership information is stored in a database of the lead generation platform for all profiles of the platform.

FIG. 3 also conceptually illustrates the leads that each business 220-260 has made available to its network partners. As shown, business 220 has provided two leads and each of the established network partners of business 220 (i.e., businesses 240 and business 260) has provided four leads, where a lead is represented by each of the graphics 330. As will be described in greater detail below, business 220 can then create a marketing campaign targeting each of the leads offered by businesses 240 and 260. The marketing campaign can include a Groupon style campaign, whereby discounted goods and services that can be prepurchased are offered to the leads. However in this model, there is no fee sharing with a middleman marketing service provider.

A business can expand its partnership network either in the aforementioned way of searching for other businesses of interest, or the business can search through the network partners of its network partners in order to identify other businesses of interest. This is a quick way to build up one's network, because it is likely that the network partners of an already established network partner will share some commonality with the particular business or the already established network partners. For example, a business that partners with its supplier, may identify from the supplier's partner network, a shipping business that the supplier uses. The business can then handshake with the shipping business when the business is in need of such a service provider.

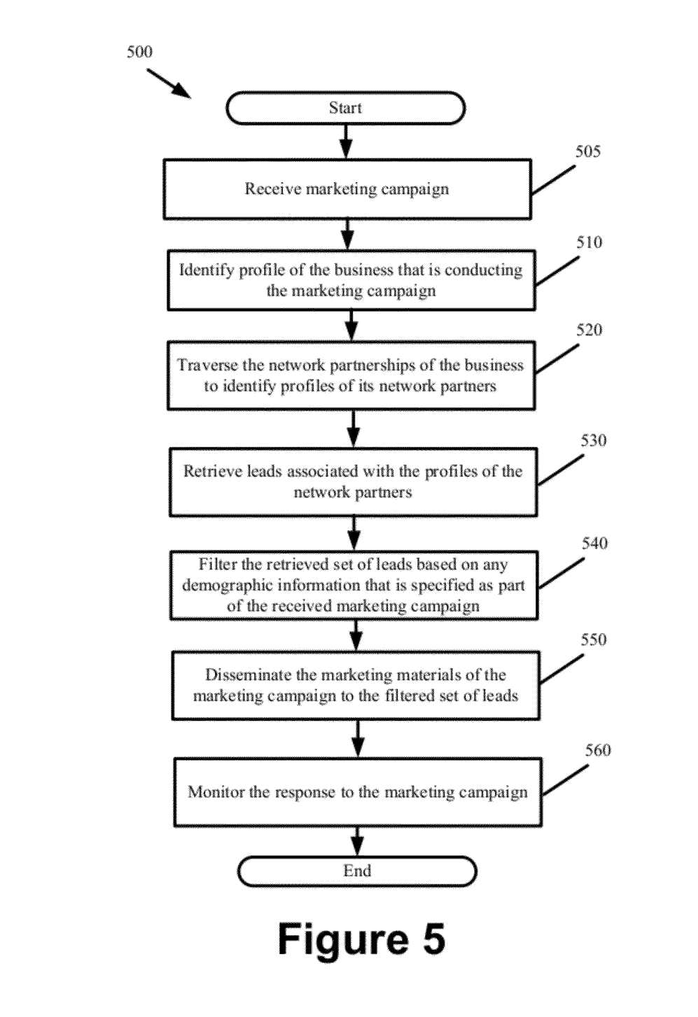

FIG. 4 conceptually illustrates identifying two businesses of interest 410 and 420 from already established network partners, and handshaking with those businesses in accordance with some embodiments. As shown, business 220 sends a handshaking request to business 410 which is a network partner of business 240. Business 220 also sends a handshaking request to business 420 which is a network partner of business 260.

In addition to the above described manner of establishing network partnerships, some embodiments of the lead generation platform import network partnership information for participating businesses from third party networking sites that businesses have already registered with and have created partnerships therein. For example, the lead generation platform can import partnership information from the networking sites www.linkedin.com or www.spoke.com. Consequently, participating businesses do not need to reestablish partnerships that they established elsewhere. Rather, a business creates a profile at the lead generation platform by entering its leads. The lead generation platform automatically imports the network partnerships that the business has established at other network sites. To reestablish the partnerships, the lead generation platform automatically identifies profiles for the imported partners and automatically establishes partnerships between the identified profiles and the profile created by the business at the lead generation platform, thereby providing the business access to the leads of its network partners without the business having to manually reestablish the necessary partnerships.

C. Lead Sharing

One of the purposes of establishing the network partnerships is to enable businesses to share resources with their network partners such that by sharing one resource, a business can gain access to a pool of the same or similar resource from its network partners. In so doing, the business can scale its resources through a system of reciprocity that requires no extra investment or cost by the business as the resources the business shares are resources already in the possession of the business. Such a platform is especially well suited for purposes of lead generation, wherein the resources being shared are the leads of the businesses and the sharing of the leads allows businesses to conduct marketing campaigns to a large scale of leads that were previously not available to a small business or a business that could not afford the cost of purchasing leads, performing market research, or using third party marketing service providers. In other words, small businesses can now market to a user base previously available only to the large business. This user base is not created through extra cost to the small business, but through a federated approach whereby the existing resources (or leads) of each small business participating in the federation are aggregated to form a shared pool of resources that is sharable amongst the small business participants and that is of the scale ordinarily available only to the large business.

To utilize the shared leads, a business creates a marketing campaign which can be embodied in many different forms such as coupons, informational newsletters, upcoming events, and discounted promotions for future goods and services. In some embodiments, the business is free to create any form of marketing campaign so long as the campaign complies with the rules of the lead generation platform. The rules may prohibit, for example, the marketing of lewd, indecent, or otherwise inappropriate content or the rules may prohibit promotions that expire within a short period of time, that are valid subject to excessive restrictions, etc.

Simple marketing campaigns involve the dissemination of marketing materials with no further action by the lead generation platform. More complex marketing campaigns involve e-commerce type transactions. Such complex marketing campaigns disseminate marketing materials to a set of leads and those marketing materials include various purchasable promotions, goods, and services. For example, the marketing campaign for a service oriented business may involve a promotion to purchase a future service (e.g., a salon haircut) at a discounted current rate.

In some embodiments, the lead generation platform provides various tools to facilitate the creation of a marketing campaign. These tools may provide interactive graphical interfaces with which a business can design its marketing materials. Alternatively, the marketing campaign may be created remote from the lead generation platform and uploaded to the lead generation platform. The marketing campaign is then associated with the profile of the corresponding business by having the business login to its profile before creating or uploading the marketing campaign. The campaign is stored to the lead generation platform database in conjunction with the associated business profile. The business then schedules when and how the campaign is to be disseminated by the lead generation profile.

In some embodiments, the lead generation platform may include a verification process to ensure that the business can comply with its offered coupons, promotions, goods, services, etc. Furthermore, the lead generation platform may include a verification process to ensure that the marketing campaign complies with the rules of the lead generation platform. The verification processes may be manually performed by a lead generation platform auditor or automatically performed using a set of scripts that ensure compliance with the rules.

Once a marketing campaign has been created or uploaded by a particular business, the lead generation platform automatically disseminates the marketing campaign to a set of leads at a scheduled time and duration that is specified by the particular business. The particular business can specify that the marketing campaign is to be disseminated to all leads of all network partners or to a subset of leads of a subset of network partners that satisfy demographic information specified by the particular business.

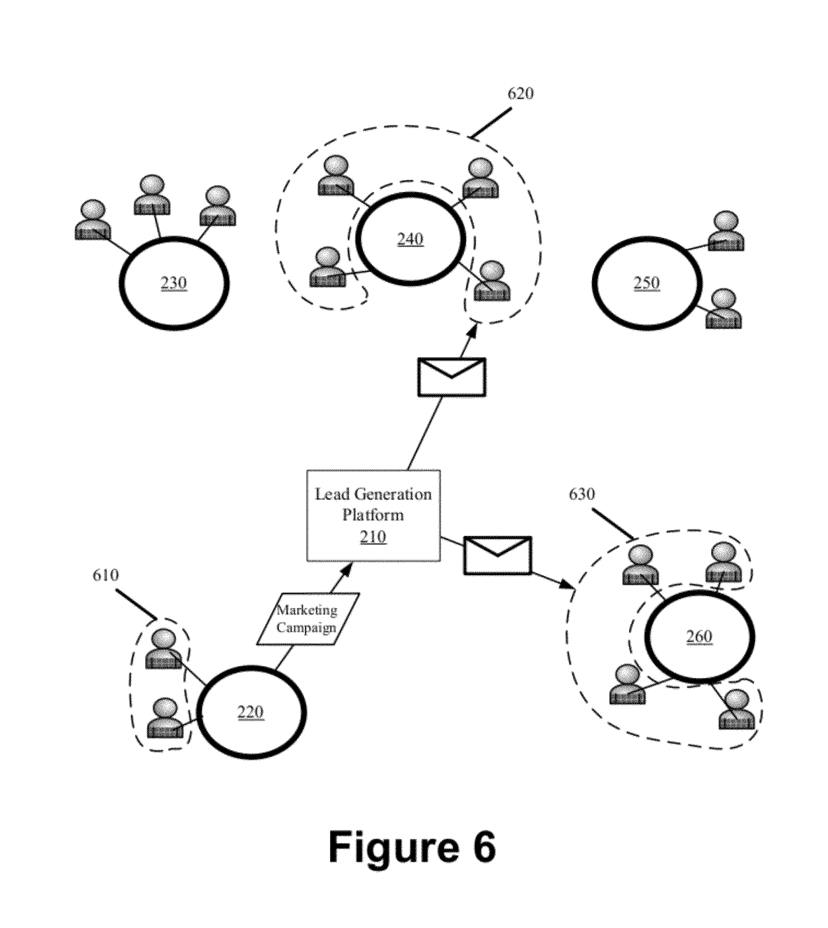

FIG. 5 presents a process 500 performed by the lead generation platform in accordance with some embodiments to automatically disseminate a marketing campaign on behalf of a business. The process 500 begins by receiving (at 505) a marketing campaign that is created or uploaded by a business and that is scheduled for dissemination. The process identifies (at 510) the profile of the business that is conducting the marketing campaign. The process traverses (at 520) the network partnerships established for the identified profile to identify profiles of the business' network partners.

Next, the process retrieves (at 530) the leads entered and associated with the profiles of the network partners. This includes retrieving the contact information for each of the leads. In some embodiments, no information about the leads of the network partners is revealed to the business conducting the marketing campaign. In some other embodiments, identifying information or demographic information for the leads may be revealed, but the contact information for those leads will be held in confidence. This maintains confidentiality of the leads and prevents participating businesses from exploiting the leads of its network partners.

The process filters (at 540) the retrieved set of leads based on any demographic information that is specified as part of the received marketing campaign. This allows the business conducting the marketing campaign to better target a specific set of leads and to generate different marketing campaigns for leads falling within different demographics. For example, the business may desire the marketing campaign to target only females ages 30-40. The process extracts the demographic parameters from the received marketing campaign and processes the retrieved set of leads of the network partners to discard any leads that do not fall within the specified parameters. Continuing with the example, leads that do not include females ages 30-40 will not receive the marketing materials from the marketing campaign. It is noted that a precondition for performing the filtering is for each participating business to provide the demographic information for the leads that it enters to the lead generation platform.

The process disseminates (at 550) the marketing materials of the marketing campaign to the filtered set of leads. Various automated interfaces are operated by the lead generation platform in order to facilitate the dissemination of marketing materials. For instance, the lead generation platform operates one or more email accounts when sending marketing materials to email accounts of the filtered leads; the lead generation platform operates one or more social media accounts when sending marketing materials through social media; the lead generation platform operates one or more telephone lines when sending marketing materials as audio, SMS, or text messages. The lead generation platform may also employ a combination or automated and manual interfaces for the dissemination of certain marketing materials. For example, automated interface may be used to print physical mailings incorporated the marketing materials with such mailings being sent manually through the postal system or various carriers.

In some embodiments, the lead generation platform performs various formatting to the marketing campaign prior to its dissemination in order for the marketing materials to be properly transferred and presented over different transfer mediums. For instance, the marketing materials are formatted differently when being disseminated via email to a first lead than when being disseminated via an SMS message to a second lead. Other transfer mediums available with which the marketing campaign may be disseminated include text messages, social networking messages, such as Twitter tweets and Facebook wall posts, and audio dissemination using voicemail and telephone messages.

Depending on the marketing campaign, the process 500 may continue to run after dissemination. This is to allow the process to monitor (at 560) the response to the marketing campaign. Monitoring the response may include tracking the number of “click-throughs” when the disseminated materials include hyperlinks to other content or websites, tracking negative replies (e.g., leads requesting to be removed or unsubscribed), or tracking and facilitating e-commerce transactions resulting from the marketing campaign. This monitored information can then be processed and presented to the business conducting the marketing campaign so that the business can ascertain the effectiveness of the campaign. In some embodiments, facilitating e-commerce transactions involves accepting payment for the sale of promotions, goods, and services and sending redemption vouchers to those that have purchased the promotions, goods, and services. Received payments are funded to the account of the business conducting the marketing campaign. In this manner, participants in the lead generation platform can conduct Groupon style marketing campaigns.

To fund the provided functionality and services, the lead generation platform may receive a small percentage (e.g., 0.5%-5%) of each sale completed as a result of marketing conducted using the lead generation platform. This percentage is lower than that charged by existing marketing service providers, since the lead generation platform of some embodiments does not need to engage in marketing in order to obtain its leads. The lead generation platform obtains its leads directly from its business participants, whereas services like Groupon and LivingSocial receive no leads from their business participants and therefore engage in expensive marketing to promote their brand and receive user signups to be used as leads for the participating businesses. In some embodiments, the lead generation platform funds its services through a subscription model wherein each business participant pays a monthly or yearly fee to have access to the lead generation platform and the leads of its network partners. In some embodiments, the lead generation platform funds its services by charging a nominal fee (e.g., a fraction of a cent) for each item of marketing materials that is sent to a lead of a network partner. This model is similar to websites displaying advertising content on their pages without users clicking on the advertising content.

In some embodiments, the lead generation platform automatically regulates the marketing campaigns being disseminated. Such regulation includes limiting the number of times a business can market to the same leads within a particular time period. In some embodiments, regulation includes restricting the leads that a business can market to based in proportion to the number of leads that the business has shared with its network partners.

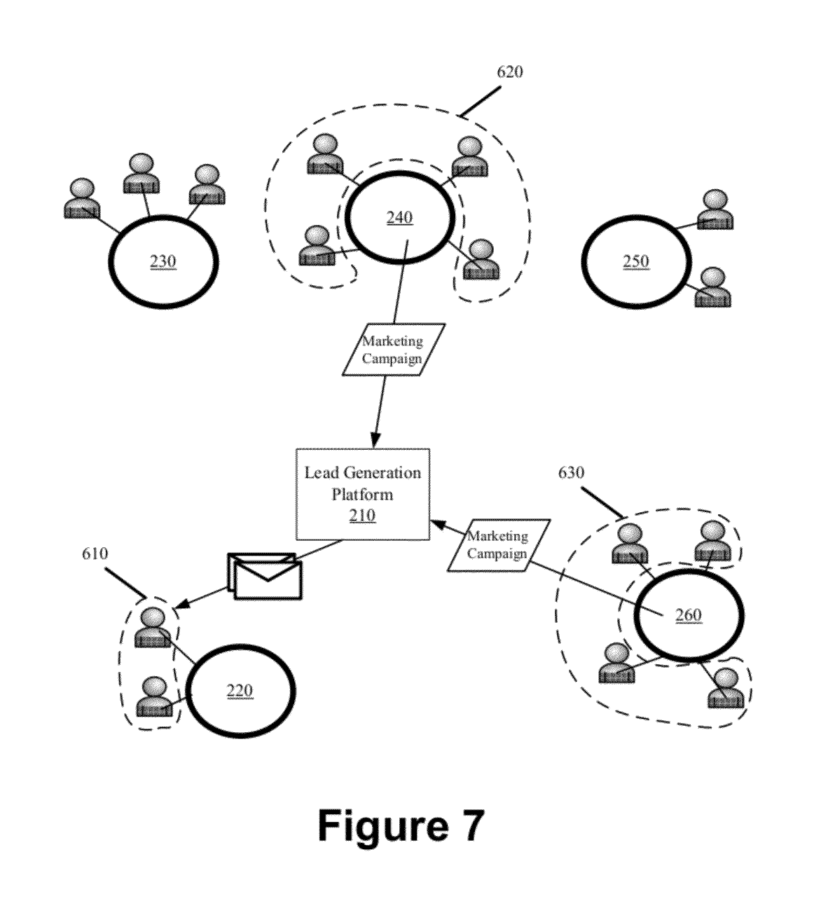

FIGS. 6-7 conceptually illustrate operation of the lead generation platform in accordance with some embodiments. As shown in FIG. 6, business 220 has established partnerships with businesses 240 and 260 through the above described handshaking process. Business 220 has offered two leads 610 to the lead generation platform 210 and businesses 240 and 260 have each offered four leads (i.e., 620 and 630). With the network partnerships in place, business 220 then creates a marketing campaign that is automatically disseminated by the lead generation platform 210 to the leads 620 and 630 of its network partners (i.e., businesses 240 and 260).

By virtue of reciprocity, each of the businesses 240 and 260 can in return conduct marketing campaigns to the leads 610 of business 220. As shown in FIG. 7, each of the businesses 240 and 260 uploads a marketing campaign to the lead generation platform 210. The lead generation platform then automatically disseminates the marketing materials associated with the uploaded marketing campaigns to the leads (i.e., 610) of the network partners of the businesses 240 and 260, which from FIG. 6 includes business 220. It should be noted that because business 220 has partnered with businesses 240 and 260, it does not mean that business 240 is a network partner of business 260 and vice versa.

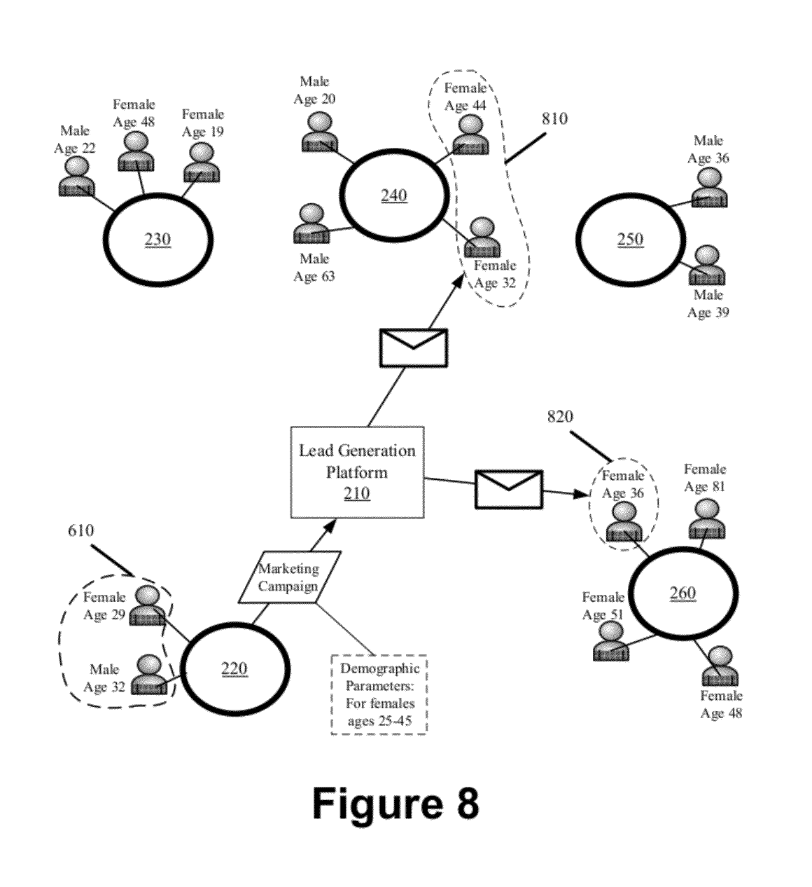

As noted above, the lead generation platform can disseminate a marketing campaign to a filtered subset of the network partner leads when supplemental demographic information is specified by the business that created or uploaded the marketing campaign and supplemental demographic information was provided when entering leads to the lead generation platform. FIG. 8 conceptually illustrates filtering the leads that receive a marketing campaign based on supplemental demographic information that are provided as part of the marketing campaign in accordance with some embodiments.

In this figure, business 220 creates or uploads a marketing campaign with supplemental demographic information. The supplemental demographic information targets the marketing campaign to females ages 25-45. The lead generation platform 210 receives the marketing campaign and identifies the network partners of business 220. As shown, the network partners include businesses 240 and 260, each of which have offered four leads that business 220 can market to. The lead generation platform 210 filters the eight leads using the specified supplemental demographic information such that the marketing campaign is sent to two of four leads of business (see reference markers 810) and one of four leads of business (see reference marker 820). Specifically, business 240 offers four leads two of which are male and therefore do not fall within the supplemental demographic information specified by business 220, though the other two (810) satisfy the supplemental demographic information. Business 260 also offers four leads. All of the four leads are female, but only one of the four females (820) falls within the age range specified in the supplemental demographic information by business 220.

D. Lead Access Controls

In some embodiments, the lead generation platform provides lead access controls with which users can specify which businesses can market to them. To access the lead access controls, users register with the lead generation platform in a similar manner to how a business registers. The users then traverse various network partnerships in order to specify which businesses can market to them.

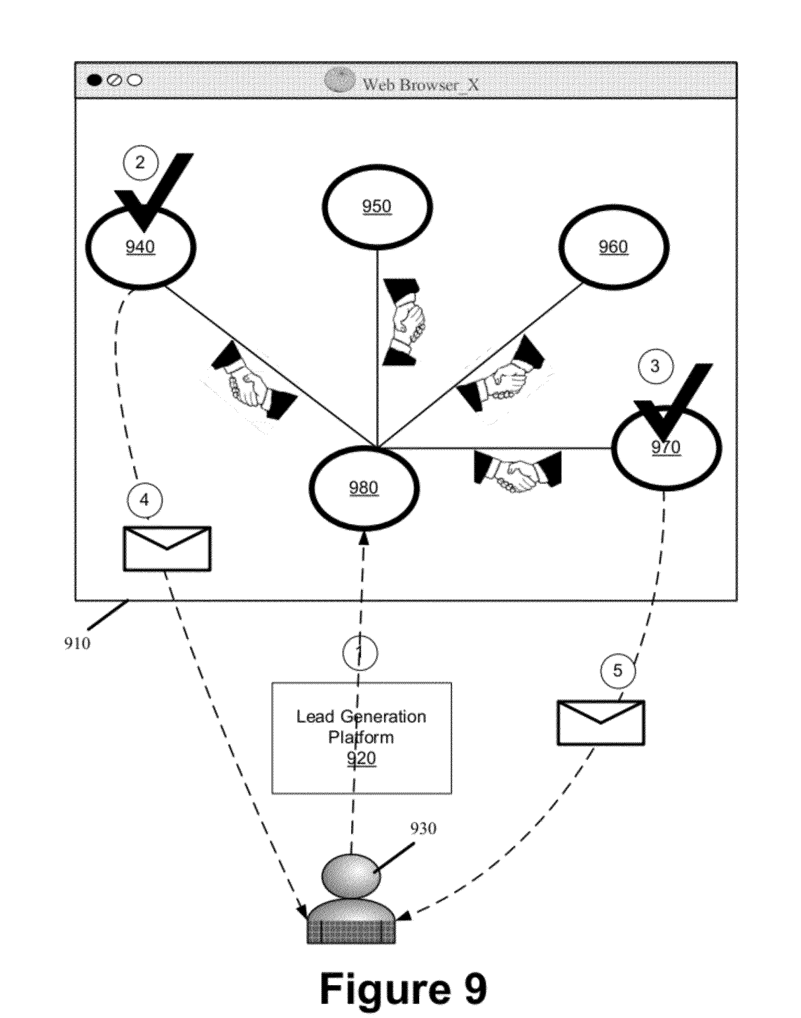

FIG. 9 illustrates users specifying lead access controls in accordance with some embodiments. The figure illustrates a web browser interface 910 that is provided by the lead generation platform 920 to a registered user 930. Through the interface 910, the user 930 can search for the profiles of one or more businesses that the user 930 trusts, frequents, or otherwise transacts with for the purpose of identifying other businesses that provide similar or related goods and services and that have the same credibility and quality of goods and services as the searched for business. The user 930 identifies these other businesses by traversing the network partners of the searched for business. In this figure, the interface 910 shows the network partners 940, 950, 960, and 970 for the searched for business 980. The network partners 940-970 will, for the most part, identify businesses that are recommended by the searched for business 980 by virtue of the business 980 having established partnerships with these other businesses 940-970. In this manner, the lead generation platform 920 can also be used as a referral platform.

The network partners 940-970 are shown in this figure using graphical representations. When the user 930 clicks on a graphical representation, the web browser interface 910 will change to display the profile of the corresponding business. Either from the business profile screen or from the network partnerships screen, the user 930 can select different businesses that he/she is interested in receiving marketing materials from. When a business is selected, the user 930 becomes a lead to which that business can market to. In this figure, the user 930 has selected to receive marketing materials from businesses 940 and 970 as represented by the check marks over the graphical representations. As a result of the selection, previously created or uploaded marketing campaigns from businesses 940 and 970 will be sent to the user 930. Additionally, future marketing campaigns created or uploaded by the businesses 940 and 970 will be sent to the user 930. As noted above, the lead generation platform 920 may keep the identity of the user 930 hidden from the businesses 940 and 970.

III. Architecture

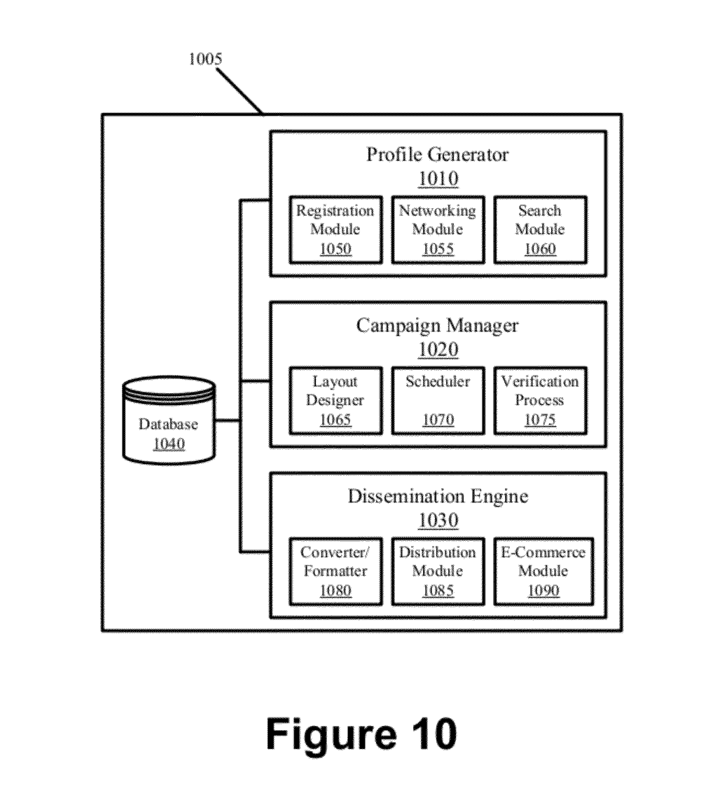

FIG. 10 illustrates various components and modules of the lead generation platform 1005 in accordance with some embodiments. As shown, the lead generation platform 1005 is implemented by profile generator 1010, campaign manager 1020, dissemination engine 1030, and database 1040.

The profile generator 1010 is comprised of registration module 1050, networking module 1055, and search module 1060. The campaign manager 1020 is comprised of layout designer 1065, scheduler 1070, and verification process 1075. The dissemination engine 1030 is comprised of converter/formatter 1080, distribution module 1085, and e-commerce module 1090.

Some or all of these components 1010-1090 are embodied as software applications or processes that are stored to non-transitory computer-readable media and that execute on one or more physical computing devices. Collectively, the components 1010-1090 transform general purpose computing resources of the computing devices to implement and perform the specific lead generation platform 1005 functionality described herein. In other words, the computing devices on which the lead generation platform 1005 executes comprise general purpose processors, random access memory, non-volatile storage, and network resources that are transformed by the components 1010-1090 of the lead generation platform 1005 into one or more specific purpose machines that perform large scale marketing for small businesses that otherwise would have access to a limited set of leads. Accordingly, the tangible results of the lead generation platform 1005 include generating business leads on the basis of reciprocity and the dissemination of marketing materials embodied as emails, SMS messages, text messages, audio messages, physical mailings, etc. to those leads.

The profile generator 1010 is the component of the lead generation platform 1005 that businesses first interact with in order to participate in the lead generation platform 1005. Using the profile generator 1010, businesses register with the lead generation platform 1005, create profiles in the lead generation platform 1005, and enter leads with or without associated demographic information to the corresponding profiles. The profiles are stored to the database 1040. The profile generator 1010 includes a network that sends and receives network packets over an external data network such as the Internet. These packets facilitate the bidirectional communication with businesses for the creation of the profiles. The profile generator 1010 further includes a processor to execute sets of instructions that implement the functionality of the registration module 1050, networking module 1055, and search module 1060.

The registration module 1050 of the profile generator 1010 creates and presents interfaces for businesses to register with the lead generation platform 1005 by creating profiles to identify the participating businesses in the lead generation platform 1005. The interfaces are presented using websites that are encoded in HyperText Markup Language (HTML), Javascript, Extensible Markup Language (XML), or some combination thereof. The interfaces may be statically or dynamically generated. For example, a registration interface may be statically presented for all businesses and profile interfaces are dynamically presented with custom business registration information.

To access the interfaces, a business directs its network connected device running a web browser or other application to a Uniform Resource Locator (URL) of the lead generation platform 1005. A registered or participating business provides login information (e.g., username and password) to gain access to the lead generation platform 1005, and more particularly, gain access to its profile. The registration module 1050 uses the provided login information to obtain and present the profile for the business from the database 1040. The business can then search for other businesses to partner with, upload leads, or upload, create, or conduct a marketing campaign. A non-registered or non-participating business is requested to create a login and a profile before being provided access to the lead generation platform 1005 functionality. The profile information may include the name of the business, identification information (e.g., address, telephone number, URL, branding, etc.), leads the business is willing to share, and other information that the business may be requested to provide or is provided voluntarily by the business for inclusion in the business profile. The profile information is stored to the database 1040. In some embodiments, the registration module 1050 imports profile information from third parties such as Dun & Bradstreet Credibility Corp. and/or www.linkedin.com.

The networking module 1055 of the profile generator 1010 implements the handshaking functionality and establishes the network partnerships between the various businesses. Accepted handshakes cause the networking module 1055 to update the profiles of the businesses involved in the handshake so that the businesses appear as network partners of one another.

The search module 1060 of the profile generator 1010 facilitates networking by allowing businesses to search for the profiles of other businesses. In this manner, businesses can learn about other businesses and use that information to determine which businesses to partner with. The search module 1060 queries the database 1040 using business/user specified parameters to obtain profiles from the database 1040.

The campaign manager 1020 is the component of the lead generation platform 1005 that businesses interact with in order to upload, create, and perform their marketing campaigns. The campaign manager 1020 also includes a network port for receiving the marketing campaigns and a processor for executing the sets of instructions that perform the functionality of the layout designer 1065, scheduler 1070, and verification process 1075. The network port and the processor may be those used by the profile generator 1010 when the campaign manager 1020 operates on the same hardware as the profile generator 1010.

The layout designer 1065 of the campaign manager 1020 facilitates creation of marketing campaigns. In some embodiments, the layout designer 1065 provides interactive tools with which a business can design its marketing campaign (e.g., specify promotions, goods and services for sale, newsletter, informational update, etc.). The layout designer 1065 also allows a business to specify supplemental demographic information so as to filter which accessible leads are to receive the marketing materials of the marketing campaign.

These tools may be accessible through a web interface or as a downloadable application. Additionally, businesses can upload marketing campaigns to the lead generation platform 1005 using the layout designer 1065. Created or uploaded marketing campaigns are stored to the database 1040.

The scheduler 1070 of the campaign manager 1020 schedules which marketing campaigns the lead generation platform 1005 is to perform, when the campaigns are to be performed, the duration the marketing campaigns are to last, and to which leads the campaigns are to be sent. In some embodiments, the scheduler 1070 presents various interfaces to a business in order for the business to schedule when and how the lead generation platform 1005 (see dissemination engine 1030 below) is to disseminate its previously uploaded or created marketing campaign(s). The marketing campaigns are accessible from the database 1040.

The verification process 1075 of the campaign manager 1020 ensures that uploaded and created marketing campaigns comply with the rules and requirements of the lead generation platform 1005. As noted above, this may include verifying that the marketing campaigns do not include lewd, illicit, or inappropriate materials and that the business conducing the campaign can meet its obligations (e.g., the business will honor its promotions). In some embodiments, the verification process 1075 is an automated process that is specified using a set of scripts and algorithms that codify the lead generation platform 1005 rules and requirements. However, it should be apparent that the verification process 1075 may replaced by manual processes in some embodiments.

The dissemination engine 1030 is the component of the lead generation platform 1005 that performs the marketing campaigns. The scheduler 1070 passes various campaigns to the dissemination engine 1030 at the scheduled times with the necessary dissemination information. The dissemination engine includes various communication interfaces to support the different mediums over which the marketing materials can be disseminated. Specifically, the dissemination engine 1030 includes an email interface, one or more social media interfaces, and a telephone interface as some examples. The email interface is the interface by which marketing materials are sent via email. The social media interfaces are the interface by which marketing materials are sent to different social media sites such as Facebook, Twitter, and the like. The telephone interface is the interface by which marketing materials are sent via an audible, SMS, or text message. The dissemination engine 1030 further includes a processor to execute the functionality of the converter/formatter 1080, the distribution module 1085, and the e-commerce module 1090.

The converter/formatter 1080 of the dissemination engine 1080 formats the received campaigns for dissemination through one or more specified transfer mediums (e.g., email, SMS messaging, text messaging, audio messages, mailings, etc.). In some embodiments, formatting the received campaign includes optimizing images or videos for the medium through which they are to be distributed. For example, hi-resolution images are down converted to low-resolution images for inclusion in an email.

The distribution module 1085 of the dissemination engine 1030 sends the marketing materials to one or more leads specified as part of the marketing campaign. As enumerated above, different transfer mediums can be used to disseminate the marketing materials and the distribution module 1085 disseminates the marketing materials over different transfer mediums depending on the contact information that is available for the specified leads. For example, the distribution module 1085 sends an email to a lead when an email address is available for that lead and the distribution module 1085 sends an SMS message or a text message to a lead when a mobile telephone number is available for that lead. When two different forms of contact are available for a lead, a preference attribute may specify which of the two forms of contact to use or the marketing materials can be sent using both forms of contact. The distribution module 1085 obtains the leads and lead contact information from the profiles of the network partners of the business conducting the marketing campaign.

The e-commerce module 1090 of the dissemination engine 1030 runs after marketing materials that include purchasing options have been disseminated. For example, a marketing campaign may cause promotions to be disseminated whereby a targeted lead can purchase a $100 massage for only $50. When the targeted lead receives that promotion, he/she can then click on a link that directs the lead to the e-commerce module 1090 and the lead can then purchase the $100 massage for $50 through interactions with the e-commerce module 1090. In some embodiments, the e-commerce module 1090 receives payment information and distributes the received payments to the appropriate business. The e-commerce module 1090 may also withdraw a certain percentage from each received payment to fund the services of the lead generation platform. In some embodiments, the e-commerce module 1090 performs other forms of tracking for disseminated marketing campaigns such as tracking the number of click-throughs, tracking the number of unsubscribe requests, tracking the number of complete transactions, etc.

Many of the above-described processes and modules are implemented as software processes that are specified as a set of instructions recorded on a non-transitory computer-readable storage medium (also referred to as a computer-readable medium). When these instructions are executed by one or more computational element(s) (such as processors or other computational elements like ASICs and FPGAs), they cause the computational element(s) to perform the actions indicated in the instructions. Computer and computer system are meant in their broadest sense, and can include any electronic device with a processor including cellular telephones, smartphones, portable digital assistants, tablet devices, laptops, and desktops. Examples of computer-readable media include, but are not limited to, CD-ROMs, flash drives, RAM chips, hard drives, EPROMs, etc.

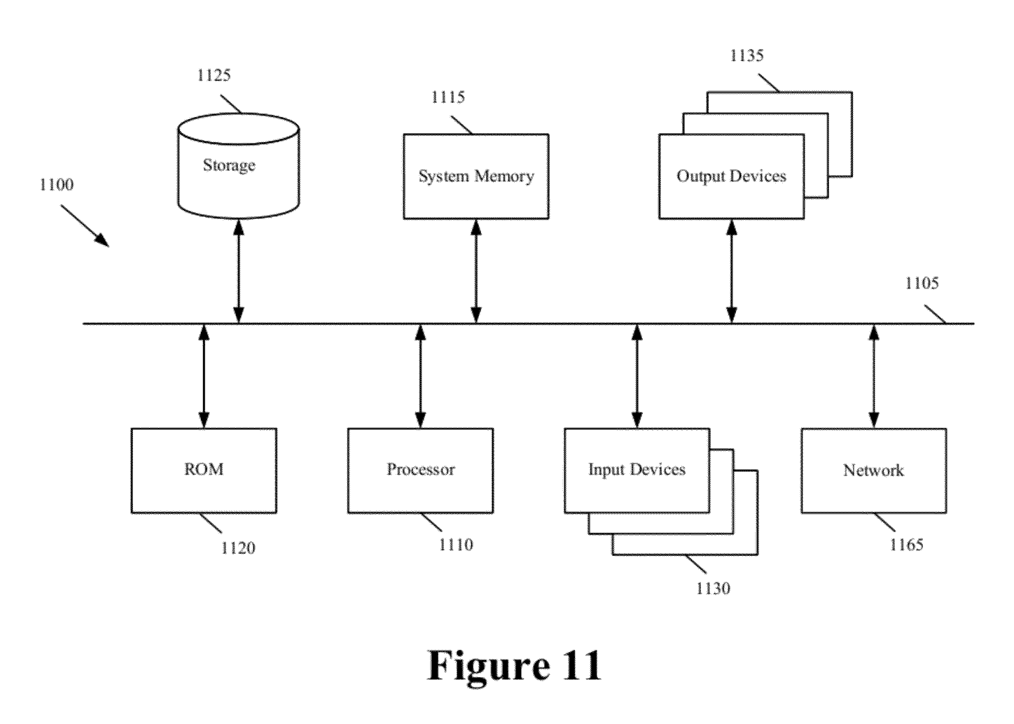

FIG. 11 illustrates a computer system with which some embodiments are implemented. Computer system 1100 includes a bus 1105, a processor 1110, a system memory 1115, a read-only memory 1120, a permanent storage device 1125, input devices 1130, and output devices 1135. Each of the profile generator 1010, campaign manager 1020, and dissemination engine 1030 of the lead generation platform may be implemented using the hardware of FIG. 11, where the components share the hardware of a single physical machine or are provided independent hardware resources of distinct virtual machines or separate physical machines.

The bus 1105 collectively represents all system, peripheral, and chipset buses that communicatively connect the numerous internal devices of the computer system 1100. For instance, the bus 1105 communicatively connects the processor 1110 with the read-only memory 1120, the system memory 1115, and the permanent storage device 1125. From these various memory units, the processor 1110 retrieves instructions to execute and data to process in order to execute the processes of the invention. The processor 1110 is a processing device such as a central processing unit, integrated circuit, graphical processing unit, etc.

The read-only-memory (ROM) 1120 stores static data and instructions that are needed by the processor 1110 and other modules of the computer system. The permanent storage device 1125, on the other hand, is a read-and-write memory device. This device is a non-volatile memory unit that stores instructions and data even when the computer system 1100 is off. Some embodiments of the invention use a mass-storage device (such as a magnetic or optical disk and its corresponding disk drive) as the permanent storage device 1125.

Other embodiments use a removable storage device (such as a flash drive) as the permanent storage device Like the permanent storage device 1125, the system memory 1115 is a read-and-write memory device. However, unlike storage device 1125, the system memory is a volatile read-and-write memory, such as random access memory (RAM). The system memory stores some of the instructions and data that the processor needs at runtime. In some embodiments, the processes are stored in the system memory 1115, the permanent storage device 1125, and/or the read-only memory 1120.

The bus 1105 also connects to the input and output devices 1130 and 1135. The input devices enable the user to communicate information and select commands to the computer system. The input devices 1130 include any of a capacitive touchscreen, resistive touchscreen, any other touchscreen technology, a trackpad that is part of the computing system 1100 or attached as a peripheral, a set of touch sensitive buttons or touch sensitive keys that are used to provide inputs to the computing system 1100, or any other touch sensing hardware that detects multiple touches and that is coupled to the computing system 1100 or is attached as a peripheral. The input device 1130 also include alphanumeric keypads (including physical keyboards and touchscreen keyboards) and pointing devices (also called “cursor control devices”). The input devices 1130 also include audio input devices (e.g., microphones, MIDI musical instruments, etc.). The output devices 1135 display images generated by the computer system. The output devices include printers and display devices, such as cathode ray tubes (CRT) or liquid crystal displays (LCD).

Finally, as shown in FIG. 11, bus 1105 also couples computer 1100 to a network 1165 through a network adapter (not shown). In this manner, the computer can be a part of a network of computers (such as a local area network (“LAN”), a wide area network (“WAN”), or an Intranet, or a network of networks, such as the Internet. For example, the computer 1100 may be coupled to a web server (network 1165) so that a web browser executing on the computer 1100 can interact with the web server as a user interacts with a GUI that operates in the web browser.

As mentioned above, the computer system 1100 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ZIP® disks, read-only and recordable blu-ray discs, any other optical or magnetic media, and floppy disks.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for operating a marketing platform based on reciprocal sharing of resources provided by a plurality of businesses participating in the marketing platform, the computer-implemented method:
generating a profile for a first business participating in the platform, said profile comprising identifying information that identifies the first business to the other plurality of businesses;
receiving contact information and demographic information for each of a first set of leads provided by the first business for association with the profile;
establishing a partnership linking the first business to at least a second business of the plurality of businesses, wherein the second business has previously generated a profile and provided contact information and demographic information for a different second set of leads that are associated with the profile of the second business;
enabling the first business to market to the second set of leads and the second business to market to the first set of leads based on the established partnership;
disseminating a first marketing campaign of the first business promoting at least one of goods and services of the first business to the second set of leads provided by the second business; and
disseminating a second marketing campaign of the second business promoting at least one of goods and services of the second business to the first set of leads provided by the first business.

2. The computer-implemented method of claim 1 further comprising receiving from the first business, a set of parameters identifying a preferred demographic for leads that are to receive the marketing campaign of the first business.

3. The computer-implemented method of claim 2 further comprising filtering the second set of leads to produce a filtered subset of the second set of leads that satisfy the set of parameters.

4. The computer-implemented method of claim 3, wherein disseminating the first marketing campaign of the first business comprises disseminating the first marketing campaign to the filtered subset of the second set of leads while preventing dissemination of the first marketing campaign to any leads of the second set of leads that are not within the filtered subset.

5. The computer-implemented method of claim 1, wherein establishing the partnership comprises handshaking between the first business and the second business.

6. The computer-implemented method of claim 5, wherein said handshaking comprises sending an invitation to the second business, the invitation comprising the identifying information for the first business.

7. The computer-implemented method of claim 6, wherein said handshaking process further comprises receiving a confirmatory reply from the second business that the second business approves establishing the partnership with the first business.

8. The computer-implemented method of claim 1, wherein disseminating the second marketing campaign of the second business comprises formatting the marketing campaign for dissemination to each lead of the first set of leads based on received contact information for each lead of the first set of leads.

9. The computer-implemented method of claim 1 further comprising brokering a financial transaction on behalf of the first business to sell at least one of a good and service of the first business to a lead of the second set of leads.

10. The computer-implemented method of claim 9 further comprising disbursing an amount of payment received as a result of brokering the financial transaction to the first business.

11. The computer-implemented method of claim 9 further comprising disbursing an amount of the payment to the platform.

12. A non-transitory computer-readable storage medium with an executable program stored thereon for a marketing platform that facilitates marketing based on the reciprocal sharing of resources obtained from a plurality of businesses participating in the marketing platform, wherein the program instructs a microprocessor of the marketing platform to perform sets of instructions for:
obtaining from a first business of the plurality of businesses, a first set of leads comprising references of the first business that have opted to receive marketing materials;
receiving marketing materials promoting at least one good and service of the first business;
configuring parameters identifying a preferred demographic of leads to receive the marketing materials;
traversing network partnerships established between the first business and any of the plurality of businesses participating in the marketing platform;
identifying a second business and a third business having established partnerships with the first business;
retrieving contact information and demographic information for a second set of leads previously obtained from the second business and a third set of leads previously obtained from the third business, wherein the second set of leads comprises references of the second business that have opted to receive marketing materials and the third set of leads comprises references of the third business that have opted to receive marketing materials;
filtering the second set of leads and the third set of leads using the configured demographic parameters to produce a subset of leads, the subset of leads comprising leads from the second and third sets of leads that satisfy the configured demographic parameters; and
disseminating the marketing materials promoting the at least one good and service of the first business on behalf of the first business to the subset of leads based on the retrieved contact information.

13. The non-transitory computer-readable storage medium of claim 12, wherein the program further comprises receiving marketing materials promoting at least one good and service of the second business.

14. The non-transitory computer-readable storage medium of claim 13, wherein the program further comprises retrieving the first set of leads based on the established partnership between the first business and the second business.

15. The non-transitory computer-readable storage medium of claim 14, wherein the program further comprises disseminating the marketing materials promoting the at least one good and service of the second business on behalf of the second business to at least one lead of the first set of leads.

16. The non-transitory computer-readable storage medium of claim 12, wherein the program further comprises preventing the first business from obtaining contact information for any lead of the second set of leads and the third set of leads.

17. The non-transitory computer-readable storage medium of claim 12, wherein the marketing materials comprise at least one of an advertisement, promotion, coupon, and product information.

18. The non-transitory computer-readable storage medium of claim 12, wherein the program further comprises monitoring a response of the subset of leads to the dissemination of the marketing materials.

19. The non-transitory computer-readable storage medium of claim 18, wherein the program further comprises presenting results of said monitoring to the first business.

20. A non-transitory computer-readable storage medium with an executable program stored thereon for a marketing platform that facilitates marketing based on the reciprocal sharing of resources obtained from a plurality of businesses participating in the marketing platform, wherein the program instructs a microprocessor of the marketing platform to perform sets of instructions for:
generating a profile for a first business participating in the platform, said profile comprising identifying information that identifies the first business to the other plurality of businesses;
receiving contact information and demographic information for each of a first set of leads provided by the first business for association with the profile;
establishing a partnership linking the first business to at least a second business of the plurality of businesses, wherein the second business has previously generated a profile and provided contact information and demographic information for a different second set of leads that are associated with the profile of the second business;
enabling the first business to market to the second set of leads and the second business to market to the first set of leads based on the established partnership;
disseminating a first marketing campaign of the first business promoting at least one of goods and services of the first business to the second set of leads provided by the second business; and
disseminating a second marketing campaign of the second business promoting at least one of goods and services of the second business to the first set of leads provided by the first business.
